(19) United States
(12) Patent Application Publication
(10) Pub. No.: US 2007/0104971 A1
(43) Pub. Date: May 10, 2007

(54) Film with outer layer composed of a polyamide composition

(75) Inventors: Roland Wursche, Dulmen (DE); Franz-Erich Baumann, Dulmen (DE); Beatrice Kuting, Marl (DE); Martin Wielputz, Munster (DE); Patrick Kreidler, Recklinghausen (DE); Harald Hager, Freigericht (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 11/586,526

(22) Filed: Oct. 26, 2006

(30) Foreign Application Priority Data
Oct. 26, 2005 (DE) 10 2005 051 126.0

(51) Int. Cl. B32B 27/34

(52) U.S. Cl. 428/474.4

(57) ABSTRACT

A decorative film having an outer layer containing a polyamide composition with the following components: a) from 50 to 100 parts by weight of polyamide prepared from: α) from 70 to 100 mol % of diamine selected from m-xylylenediamine, p-xylylenediamine and mixtures thereof, β) from 0 to 30 mol % of other diamines having from 6 to 14 carbon atoms, and γ) from 70 to 100 mol % of aliphatic dicarboxylic acids having from 10 to 18 carbon atoms and δ) from 0 to 30 mol % of other dicarboxylic acids having from 6 to 9 carbon atoms, and b) from 0 to 50 parts by weight of another polyamide, where a) and b) total 100, having good chemicals resistance, good stress cracking resistance, improved scratch resistance, and improved gloss.

The entire disclosure of German Patent Application No. 102005051126.0, filed on Oct. 26, 2005, including specification, claims, and summary is incorporated herein by reference in its entirety.

The present invention relates to a film having a layer composed of a polyamide and which is suitable for the decoration of moldings.

### BACKGROUND OF THE INVENTION

Molding compositions containing polyamides have advantageous properties for production of a very wide variety of consumer articles. The combination of these properties with the feature of transparency is of particular interest, and opens up the possibility of production of transparent films that can be used for the finishing or decoration of surfaces. Materials that can be used here are especially polyamides having relatively long-chain aliphatic monomer components, because they have particular impact resistance, even at low temperatures, good chemicals resistance, and adequately good scratch resistance and adequate gloss. Examples of such polyamides are PA12, PA11, PA1010, PA1012 or their blends.

These properties are relevant by way of example for applications as material for outer layers in the ski and snowboard sector. Examples are found in the article by M. Beyer and J. Lohmar, Kunststoffe 90 (2000) 1, pp. 98-101, which mentions printable films composed of PA12 molding compositions.

DE 295 19 867 U1 describes a decorable film composed of a copolyamide that is composed of laurolactam and caprolactam and/or hexamethylenediamine/dicarboxylic acid as monomer units. Although these copolyamides are generally transparent and can also be decorated to good effect, when moldings or films are produced from these copolyamides via extrusion, problems always occur. In particular—as with the systems mentioned above—deposits form on the injection mold or extrusion tooling or on the take-off rolls, and these deposits often cause interruption of production because cleaning operations are needed. Furthermore, these films have insufficient heat resistance, and there is therefore a risk of deformation during decoration by means of sublimation print or by means of thermal diffusion print. Decoration therefore has to be carried out at temperatures lower than would actually be desirable in these processes.

A factor of general importance for selection of material for the application sector mentioned, alongside a low level of deposit formation and good heat resistance, is that a certain degree of crystallinity is present simultaneously with and in addition to transparency. This property is important for the resistance of the material to chemicals; an example of the way in which this property is apparent here being via satisfactory stress cracking resistance when the material is printed (printing ink) or comes into contact with cleaning compositions.

However, achievement of increase in scratch resistance and gloss would be a desirable improvement over the above-mentioned prior art.

Polyamides can also be used as outer layers of paint replacement films in the vehicle sector. The standard current process for the decoration of external areas on automobiles is painting. However, this procedure firstly generates high manufacturing costs, resulting from provision of specific machinery and from the attendant operating cost for the automobile manufacturer, and secondly this procedure pollutes the environment. Environmental pollution results, for example, from solvent residues released from the paints used, and from colorant residues arising, for which correct disposal methods have to be used. Another factor here is that the painting process has only limited suitability for decorating the surface of plastics components which in recent years have become increasingly popular in automobile construction because they save weight and cost.

The process of painting plastics components that are components of bodywork can, for example, be carried out on-line, the plastics part being subjected to a paint treatment identical with that for the metallic components. This treatment leads to a uniform color, but is attended by high temperatures resulting from the cathodic electrodeposition method conventional here, making the selection of material more difficult. In addition, identical adhesion of the paint formulation has to be ensured on very different substrates. If the process of painting the plastics parts is carried out in a separate step (known as off-line painting), using process conditions more advantageous for plastics, the problem of color-matching arises, meaning that the shade achieved on the metal has to be matched precisely. However, the differences in substrate and in the underlying paint formulation that can be used, and process conditions, make this matching very difficult to achieve. If there is a color difference prescribed via the design, a serious disadvantage that remains is having to provide a second set of painting equipment for the plastics parts and the cost associated therewith; additional time required for manufacture of the automobile also has to be considered. Direct use of the untreated, generally injection-molded plastics parts is aesthetically disadvantageous, because surface defects resulting from the process, such as weld lines, air inclusions, and also necessary reinforcing fillers, such as glass fibers, are clearly discernible here. These defects are intolerable in visible regions. Consequently, improvement of surface quality has to be undertaken, for example in the context of a painting process, frequently requiring much work for pretreatment via polishing and application of relatively thick layers of a primer.

One proposed solution involves the use of multilayered plastics films to cover the components; here no painting is required. The bond between substrate and decorating film here can be achieved via a number of manufacturing processes. By way of example, the film can be laminated to the substrate, or it is possible to select a process of reverse coating by an injection-molding process, in which the film is placed in the injection mold during component production. The concept of a film as carrier of decoration is also in line with a trend toward individualization of design elements on automobiles. Specifically, this trend leads to a wider range of models in the manufacturing process, but with a reduction in the number of respective components manufactured per series. The use of films permits rapid, problem-free design change, and can therefore meet this challenge. An important factor here is that the film complies with the standards demanded in the automobile industry with respect to surface properties (class A surface), solvent resistance, and appearance. These films likewise have good capability for use in the design of interior surfaces in automobiles.

Decorative films of this type are in principle known. EP 0 949 120 A1 describes by way of example decorative films with a transparent outer layer composed of polyurethane, polyacrylate, fluoropolymer, or mixtures composed of fluoropolymer and polyacrylate. WO 94/03337 and EP 0 285 071 A2 disclose similar decorative films.

Because of their property profile, for example impact resistance and chemicals resistance, polyamides, in particular polyamides based on PA12 or PA11, very generally have good suitability for the production of decorative films of this type. Accordingly, the patent literature contains descriptions of decorative films or else protective films that have an outer layer composed of a polyamide. JP60155239A, JP2003118055A, EP 1 302 309 A, EP 0 522 240 A, EP 0 694 377 A, EP 0 734 833 A, WO9212008 A and EP 0 568 988 A may be mentioned here by way of example.

Whereas outer layers composed of polyamides with high carboxamide group density have insufficient chemicals resistance and excessive water absorption, due to high polarity, it has been found in practice that when polyamides having low carboxamide group density, prepared from lactams and, respectively, from the corresponding aminocarboxylic acids (AB polyamides), are used the result is that under ambient conditions over the course of time deposits form on the surface of the films and considerably reduce gloss and are unacceptable for this application. Polyamides of this type, e.g. PA11 or PA12, moreover have inadequate scratch resistance. Their gloss is also unsatisfactory.

### DESCRIPTION OF THE INVENTION

An object of the invention was therefore to provide a single-layer or multilayer film that serves for decorative purposes and one layer or the uppermost layer (both hereinafter termed outer layer) of which is composed of a polyamide composition that has good chemicals resistance and stress cracking resistance and improved scratch resistance, has no tendency toward formation of deposits, and has improved gloss, thus meeting the increased level of aesthetic demands placed upon the surface, even after prolonged use. The outer layer here has to have sufficient transparency to permit reverse printing with adequate character sharpness.

This object has been achieved via a single or multilayer decorative film whose outer layer is composed of a polyamide composition having the following components:
a) from 50 to 100 parts by weight, preferably from 60 to 98 parts by weight, particularly preferably from 70 to 95 parts by weight and with particular preference from 75 to 90 parts by weight, of polyamide that can be prepared from the following monomers:
   α) from 70 to 100 mol %, preferably from 75 to 99 mol %, particularly preferably from 80 to 98 mol % and with particular preference from 85 to 97 mol %, of m-xylylenediamine and/or p-xylylenediamine and
   β) from 0 to 30 mol %, preferably from 1 to 25 mol %, particularly preferably from 2 to 20 mol % and with particular preference from 3 to 15 mol %, of other diamines having from 6 to 14 carbon atoms,
   where the mol % data here are based on the entirety of diamine, and
   γ) from 70 to 100 mol %, preferably from 75 to 90 mol %, particularly preferably from 80 to 98 mol % and with particular preference from 85 to 97 mol %, of aliphatic dicarboxylic acids having from 10 to 18 carbon atoms and
      δ) from 0 to 30 mol %, preferably from 1 to 25 mol %, particularly preferably from 2 to 20 mol % and with particular preference from 3 to 15 mol %, of other dicarboxylic acids having from 6 to 9 carbon atoms,
where the mol % data here are based on the entirety of dicarboxylic acid;
b) from 0 to 50 parts by weight, preferably from 2 to 40 parts by weight, particularly preferably from 5 to 30 parts by weight and with particular preference from 10 to 25 parts by weight, of another polyamide, preferably a polyamide with an average of at least 8 carbon atoms in the monomer units, where the parts by weight of a) and b) give a total of 100.

The polyamide composition can moreover contain at most 20% by weight, at most 16% by weight, at most 12% by weight, at most 8% by weight, or at most 4% by weight, of auxiliaries or additives, the % by weight data here being based on the entire polyamide composition.

The other diamine used concomitantly, if appropriate, under a) β) can by way of example be 1,6-hexamethylenediamine, 1,8-octamethylenediamine, 1,9-nonamethylenediamine, 1,10-decamethylenediamine, 1,12-dodecamethylenediamine, 1,14-tetradecamethylenediamine, 1,4-cyclohexanediamine, 1,3- or 1,4-bis(aminomethyl)hexane, 4,4′-diaminodicyclohexylmethane and/or isophoronediamine.

The dicarboxylic acid of component a) γ) is preferably linear. Examples of suitable compounds are 1,1 0-decanedioic acid, 1,11 -undecanedioic acid, 1,1 2-dodecanedioic acid, 1,13-tridecanedioic acid, 1,14-tetradecanedioic acid, 1,16-hexadecanedioic acid and 1,18-octadecanedioic acid, preference being given here to 1,12-dodecanedioic acid and 1,14-tetradecanedioic acid. Mixtures can also be used.

Examples of the other dicarboxylic acid used concomitantly, if appropriate, under a) δ) are adipic acid, suberic acid, 1,9-nonanedioic acid, 1,4-cyclohexanedicarboxylic acid, isophthalic acid and/or terephthalic acid.

In one preferred embodiment, the polyamide contain under a) essentially no monomer units that derive from a component a) β).

In another preferred embodiment, the polyamide contain under a) essentially no monomer units that derive from a component a) δ).

A further preference is that the monomer units that derive from component a) γ) derive from a single dicarboxylic acid, because although mixtures of dicarboxylic acids give higher transparency of the polyamide, the result is reductions in chemicals resistance.

In one possible embodiment of the invention, component a) α) is composed of

at least respectively 50% by weight, 60% by weight, 70% by weight, 75% by weight, 80% by weight, 85% by weight, 90% by weight or 95% by weight, of m-xylylenediamine and

at most respectively 50% by weight, 40% by weight, 30% by weight, 25% by weight, 20% by weight, 15% by weight, 10% by weight or 5% by weight, of p-xylylenediamine.

In another possible embodiment of the invention, component a) α) is composed of more than 50% by weight, respectively at least 60% by weight, 70% by weight, 75% by weight, 80% by weight, 85% by weight, 90% by weight or 95% by weight, of p-xylylenediamine and

less than 50% by weight, respectively at least 40% by weight, 30% by weight, 25% by weight, 20% by weight, 15% by weight, 10% by weight or 5% by weight, of m-xylylenediamine.

Component a) can be composed of a mixture of two or more different polyamides that per se respectively have the composition described under a).

Although the polyamide of b) can, for example, be PA6 or PA66, preference is given to higher polyamides having an average of at least 8 carbon atoms in the monomer units, e.g. PA88, PA610, PA612, PA614, PA810, PA812, PA814, PA1010, PA1012, PA1014, PA1212, PA11 or PA 12. Further preference is that the polyamide of b) derives from a diamine sterically similar to xylylenediamine, i.e. that the monomer units formed from this compound have a similar length, this being the case with hexamethylenediamine, for example. It is moreover advantageous that the polyamide of b) and the polyamide a) derive from the same, or from a similar, dicarboxylic acid. Substantially transparent blends can be obtained most readily in these instances.

The polyamide composition can also comprise the following other components:
a) nucleating agents, selected from nanoscale fillers and basic metal salts, metal oxides or metal hydroxides; the amount of the latter used is, in order to ensure the desired transparency, at most the amount that can be dissolved in the melt with reaction with the carboxy end groups of the polyamides;
b) conventional auxiliaries and, respectively, additives in the amounts conventional for polyamide molding compositions, examples being stabilizers, UV absorbers or lubricants,
c) colorants that do not significantly affect transparency,
d) fillers whose refractive index is precisely the same as or differs only slightly from that of the matrix (isorefractive fillers),
e) other polymer components whose refractive index is precisely the same as or differs only slightly from that of the matrix, and
f) nucleating agents based on organic compounds that do not substantially affect transparency.

Polycondensates based on xylylenediamines are known from the literature, and this also includes the use of dodecanedioic acid as diacid (e.g. U.S. Pat. No. 3,803,102 and U.S. Pat. No. 4,433,136). Polyamides whose underlying structure comprises MXD6 or MXD 12 are used for production of films in the packaging sector (e.g. EP-A1172 202, U.S. Pat. No. 5,955,180, EP-A-0 941 837, WO 00/23508). These films can also be multilayer films. Finally, FR-A-2 740 385 describes a decorative film with a transparent, printable outer layer composed of a polyamide, with a second layer composed of a (functionalized) polyolefin and with a third layer composed of a fiber-based nonwoven material. In the claims, the polyamide MXD6 is also mentioned as a material for the outer layer. Alongside use for decorating of sports items, e.g. skis, of sanitary items, and of furniture, general mention is also made of use in automobiles. However, high water absorption of the polyamide MXD6 means that this type of structure is unsuitable for applications in the automobile sector, in particular as paint replacement, because aqueous solutions of relevant chemicals, e.g. pancreatin, penetrate into the outer layer and can damage it (the pancreatin test serving to simulate the effect of bird droppings).

There has been no description hitherto in the literature of the use of the inventive polyamide compositions for the production of scratch-resistant decorative films or of scratch-resistant paint-replacement films, or of the film structure that is specifically advantageous here. Nor has there been any disclosure in the literature hitherto of the specific advantages of the inventive compositions for the ski and snowboard sector.

For the purposes of the invention, decorative films are films that can be printed and/or comprise a color layer and moreover are intended to be bonded to a substrate in order to decorate its surface. The decoration can also be brought about by concealing optical defects of the surface, e.g. by covering surface roughness caused by fillers or reinforcing materials.

The inventive decorative film is a single-layer or multilayer film. In a multilayer embodiment, the type and number of the other layers depends on the technical requirements of the application; the only decisive factor is that the outer layer is composed of the molding composition used according to the invention. By way of example, the following embodiments are possible:
1. The film is a single-layer film. According to the definition, in this instance it is composed only of the outer layer; decorative effects can be applied either on the upper side or on the lower side via printing, e.g. by means of thermal sublimation print.
2. The film comprises not only the outer layer but also an underlying color layer.

The color layer can be a paint layer; however, it is preferably composed of a colored thermoplastics layer, corresponding to the prior art. By way of example, the thermoplastic can have a constitution identical with or similar to that of the outer layer, or can comprise a component thereof or another polyamide or, respectively, another polyamide that either adheres directly to the outer layer or has been adhesive-bonded with the aid of a sufficiently transparent adhesion promoter (for example a polyolefin functionalized using carboxy or anhydride or epoxy groups, or a thermoplastic polyurethane or a blend composed of the constituents of the layers to be bonded). Examples of colorants that can be used are organic dyes, inorganic or organic pigments, or metal flakes.
3. The film comprises not only an outer layer and, if appropriate, a color layer, but also another layer that, as backing layer, brings about sufficient mechanical strength and, if appropriate, also linkage to the substrate.
4. The film comprises not only an outer layer and, if appropriate, a color layer, but also an underlying adhesion-promoter layer for linkage to the substrate.

Examples of suitable adhesion promoters are a polyolefin functionalized using carboxy or anhydride or epoxy groups, a thermoplastic polyurethane, a blend composed of the materials of the layer to be bonded and of the substrate or one of the adhesion promoters disclosed in the German Patent Application No. 102004029217.5 of Jun. 16, 2004.
5. The film comprises not only an outer layer, and if appropriate a color layer, and a backing layer, but also an underlying adhesion-promoter layer for linkage to the substrate. With respect to the adhesion promoter, the content of point 4. is applicable.
6. The film, e.g. a film of points 1 to 5, also comprises, if required, on the outer layer, for example if there are relatively high demands placed upon scratch resistance, a protective layer, for example a clear lacquer based on polyurethane. A protective layer in the form of a lacquer can also have been modified to increase scratch resistance according to the prior art. Alongside this, it is also possible to generate a protective layer on the component by way of vacuum-deposition processes. If appropriate, there can also be a peelable protective film applied by lamination to the film to provide protection during transport or assembly, for example being peeled away after production of the composite part.

In the case of embodiments 2 to 6, the transparent outer layer can first be printed in the manner of a monofilm from one side or from both sides, this being followed by a second step bonding with the other layers to give the multilayer film. In multilayer films, e.g. films produced via coextrusion, the transparent outer layer can be printed from above. The outer layer can also be transparent or opaquely colored.

In one preferred embodiment, the color layer and/or the backing layer comprises a molding composition in particular of a polyetheramide or of a polyetheresteramide, and preferably of a polyetheramide or polyetheresteramide based on a linear aliphatic diamine having from 6 to 18 and preferably from 6 to 12 carbon atoms, on a linear aliphatic or aromatic dicarboxylic acid having from 6 to 18 and preferably from 6 to 12 carbon atoms and on a polyether having an average of more than 2.3 carbon atoms per oxygen atom and having a number-average molecular weight of from 200 to 2000. The molding composition of this layer can comprise other blend components, e.g. polyacrylates or polyglutarimides having carboxy or carboxylic anhydride or epoxy groups, a rubber containing functional groups, and/or a polyamide. Molding compositions of this type are prior art; they are described by way of example in EP 1 329 481 A2 and DE-A 103 33 005, these being expressly incorporated herein by way of reference. In order to ensure good layer adhesion, it is advantageous for the polyamide fraction of the polyamide elastomer here to be composed of monomers identical with those used in one of the components of the outer layer. However, this is not essential for achieving good adhesion. As an alternative to the polyamide elastomers, the color layer and/or the backing layer can comprise, alongside a polyamide, a conventional impact-modifying rubber. An advantage of these embodiments is that in many instances there is no need for thermoforming of the film as a separate step prior to reverse-coating by an injection-molding method, since the latter also simultaneously subjects the film to a forming process.

In one preferred embodiment, the thickness of the film or multilayer film with the inventive outer layer is from 0.02 to 1.2 mm, particularly preferably from 0.05 to 1 mm, very particularly preferably from 0.1 to 0.8 mm and with particular preference from 0.2 to 0.6 mm. If the film is a multilayer film, in one preferred embodiment the thickness of the inventive outer layer is from 0.01 to 0.5 mm, particularly preferably from 0.02 to 0.3 mm, very particularly preferably from 0.04 to 0.2 mm and with particular preference from 0.05 to 0.15 mm. The film is produced by means of known methods, for example via extrusion, or in the case of multilayer systems via coextrusion or lamination. It can then be subjected to a forming process, if appropriate.

Examples of methods of coherent bonding of the film to the substrate are adhesive bonding, pressing, lamination, or coextrusion, or reverse coating by an injection-molding, foaming, or compression-molding method. In order to achieve better adhesion, the film can by way of example be previously flame-treated or treated with a plasma. Prior to formation of the bond between film and substrate, the film can also be subjected to mechanical treatment or forming processes, e.g. via thermoforming or other processes. The surface can be structured via embossing, for example. The surface can also be pre-structured in the context of film extrusion, for example using specifically designed rolls. The resultant composite part can then also be subjected to a forming process.

Examples of suitable substrates are molding compositions based on polyolefins, on polyamides, on polyesters, on polycarbonates, on ABS, on polystyrene, or on styrene copolymers.

In one preferred embodiment, the inventive film is used as the outer layer of a film composite for the design or decoration of surfaces on and in automobiles and utility vehicles, the film having been adhesive-bonded to a plastics substrate. The correspondingly designed component can be of sheet-like structure, an example being a bodywork part, for example a roof module, wheel surround, engine cover, or door. Other possible embodiments are those in which the components produced are elongate, with or without curvature, for example cladding, e.g. the cladding on what are known as A columns of an automobile, or decorative and cover strips of any type. Another example is provided by protective cladding for door sills. Alongside applications in motor-vehicle exteriors, constituents of the interior can also be advantageously decorated via the inventive films, in particular decorative elements such as strips and panels, because impact resistance and resistance to chemicals, such as cleaners, is also required in the interior.

In another preferred embodiment, the inventive film is used as topcoat for sports equipment, for example snowboard-like equipment of any type, such as skis or snowboards.

The film can moreover be used by way of example as a protective film to counter soiling, UV radiation, effects of weathering, chemicals, or abrasion, or as a barrier film on vehicles, in the household, on floors, on tunnels, on tents, and on buildings, or as a carrier of decorative effects, for example for topcoats of sports equipment, of boats, of aircraft, in the household, or on buildings.

The invention is illustrated below by way of the following examples.

Preparation of Starting Polyamides:

1. Preparation of PA MXD6

The following starting materials were charged to a 100 l polycondensation reactor (autoclave):

| | | |
|---|---|---|
| 14.964 | kg | of m-xylylenediamine, |
| 16.058 | kg | of adipic acid, |
| 19.618 | kg | of deionized water, and |
| 3.074 | g | of a 50% strength aqueous solution of hypophosphorous |
| | | acid. |

The starting materials were melted under nitrogen and heated to about 180° C. in the sealed autoclave, with stirring, whereupon the internal pressure became about 20 bar. This internal pressure was retained for 2 hours; the melt was then heated further to 280° C. under continuous depressurization to atmospheric pressure. Nitrogen was then passed over the melt for about 1 hour while maintaining the temperature of 280° C., until the desired torque had been indicated. The melt was then discharged by means of a gear pump and strand-pelletized. The pellets were dried for 16 hours at 80° C. under the vacuum generated by a water pump.

Yield: 22.7 kg

The product had the following properties:

Crystallite melting point Tₘ: 243° C. (to DIN 53765)

Relative solution viscosity ηᵣₑₗ: 1.59 (to DIN EN ISO 307) 2. Preparation of PA MXD 10

The following starting materials were charged to a 100 ; polycondensation reactor (autoclave):

| | | |
|---|---|---|
| 11.751 | kg | of m-xylylenediamine, |
| 17.449 | kg | of 1,10-decanedioic acid (sebacic acid), |
| 18.326 | kg | of deionized water, and |
| 3.281 | g | of a 50% strength aqueous solution of hypophosphorous |
| | | acid. |

The procedure was as above.

Yield: 21.3 kg

The product had the following properties:

Crystallite melting point Tₘ: 188° C.

Relative solution viscosity ηᵣₑₗ: 1.65

3. Preparation of PA MXD12

The following starting materials were charged to a 100 l polycondensation reactor (autoclave):

| | | |
|---|---|---|
| 11.441 | kg | of m-xylylenediamine, |
| 19.347 | kg | of 1,12-dodecanedioic acid, |
| 19.57 | kg | of deionized water, and |
| 3.17 | g | of a 50% strength aqueous solution of hypophosphorous |
| | | acid. |

The procedure was as above.

Yield: 24 kg

The product had the following properties:

Crystallite melting point Tₘ: 183° C. Relative solution viscosity ηᵣₑₗ: 1.58

4. Preparation of PA MXD13

The following starting materials were charged to a 100 l polycondensation reactor (autoclave):

| | | |
|---|---|---|
| 11.761 | kg | of m-xylylenediamine, |
| 21.100 | kg | of 1,13-tridecanedioic acid (brassylic acid), |
| 21.76 | kg | of deionized water, and |
| 3.373 | g | of a 50% strength aqueous solution of hypophosphorous |
| | | acid. |

The procedure was as above.

Yield: 24.1 kg

The product had the following properties:

Crystallite melting point Tₘ: 167° C.

Relative solution viscosity ηᵣₑₗ: 1.57

5. Preparation of PA MXD14

The following starting materials were charged to a 100 l polycondensation reactor (autoclave):

| | | |
|---|---|---|
| 12.939 | kg | of m-xylylenediamine, |
| 24.544 | kg | of 1,14-tetradecanedioic acid, |
| 11.11 | kg | of deionized water, and |
| 3.88 | g | of a 50% strength aqueous solution of hypophosphorous |
| | | acid. |

The procedure was as above.

Yield: 31.2 kg

The product had the following properties:

Crystallite melting point Tₘ: 183° C.

Relative solution viscosity ηᵣₑₗ: 1.60

6. Preparation of PA MXD18

The following starting materials were charged to a 100 l polycondensation reactor (autoclave):

| | | |
|---|---|---|
| 10.880 | kg | of m-xylylenediamine, |
| 25.120 | kg | of 1,18-octadecanedioic acid, |
| 9.08 | kg | of deionized water, and |
| 4.14 | g | of a 50% strength aqueous solution of hypophosphorous |
| | | acid. |

The procedure was as above.

Yield: 29.5 kg

The product had the following properties:

Crystallite melting point Tₘ: 173° C.

Relative solution viscosity ηᵣₑₗ: 1.56

7. Preparation of PA MXD12/PXD12

The following starting materials were charged to a 100 l polycondensation reactor (autoclave):

| | | |
|---|---|---|
| 8.174 | kg | of m-xylylenediamine, |
| 3.407 | kg | of p-xylylenediamine, |
| 19.577 | kg | of 1,12-dodecanedioic acid, |
| 19.86 | kg | of deionized water, and |
| 3.230 | g | of a 50% strength aqueous solution of hypophosphorous |
| | | acid. |

The procedure was as above.

Yield: 24.9 kg

The product had the following properties:

Crystallite melting point Tₘ: 197° C.

Relative solution viscosity ηᵣₑₗ: 1.55

Processing

1. Compounding

The polyamides prepared were compounded, if appropriate together with the polyamides stated in the tables, with 0.75% by weight of a stabilizer mixture and 0.05% by weight of a nucleating agent (in each case based on the polyamide) in a Werner+Pfleiderer ZSK 30 twin-screw kneader whose barrel temperature was 240° C. (PA MXD6: 280° C.) at 150 rpm with 20 kg/hour throughput.

2. Film Extrusion

The monofilms were produced on a Collin system with take-off speed of 2.5 m/min by the chill roll process at a melt temperature of 250° C. (PA MXD6: 280° C.). Multilayer films were produced on a Collin multilayer film system using a calender unit, type 168/400, by the calendering method.

3. Reverse Coating by an Injection-Molding Method

For the wash-brush test and for the scratch resistance test, the films were reverse-coated by an injection-molding method in an Engel Victory 540/200 injection-molding machine in a high-gloss mold, using a PA12 molding composition. The dimensions of the sheets were 150×105×3 mm.

Testing of Monofilms for Chemicals Resistance

The test substances were tested in a 2610 gradient oven (manufacturer: BYK Gardner). In order to favor thermal conductivity, the films were provided with the backing of self-adhesive aluminium foil. Immediately after application of the chemicals, the films were directly placed on the Ceran surface heated stepwise via a gradient. The slide systems of the gradient oven moved onto the film at the start and, with a narrow edge, pressed the film onto the heated surface at the front and rear. After 30 minutes, the slide systems retracted and the film was removed from the heated surface and cleaned. The films were assessed visually one hour after the procedure and again 24 hours after the procedure. The result after 24 hours was the valid value; see Table 1. The stated values are the temperatures at which alterations of the surface began to be discernable visually.

It is seen that the inventive films have markedly improved stability when compared with substances relevant to external parts of automobiles.

Measurement of Gloss Values

The measurements were carried out to DIN 67530 on multilayer films; details can be seen in Table 2. Comparison is made with a multilayer film whose outer layer was composed of PA12. It is seen that according to the invention the gloss has been markedly improved.

Transmittance Measurement

Transmittance was measured on monofilms of thickness 50 μm to ISO 13468 2; see Table 3. It is seen that transparency is comparable with that of PA12 and is therefore entirely sufficient for the application in question.

Wash-Brush Resistance Test

Multilayer films reverse-coated by an injection-moulding method were tested in the Amtec-Kistler, DIN 55668:2002-08 wash-brush resistance test. The results are shown in Table 4. It is seen that markedly less damage occurs with the inventive films and, respectively, composite parts.

Measurement of Scratch Resistance

Surface gloss prior to and after a scratch test was determined by an internal Degussa company method on multilayer films reverse-coated by an injection-moulding method. The abrasion test appliance used was in accordance with Renault V. I. specification 31.03.406/A, issue of 94-06. First, the gloss was measured at various points on the test specimen. Then the test specimen was installed horizontally in the holder intended for this purpose. A sieve fabric composed of polyamide (25 μm mesh width) was wetted with 0.1 % strength Persil solution and stretched over the two rams on the underside of the lever arm. The lever arms with the abrasive rams were then swivelled over so that the rams were in contact with the test specimen, in each case with an added weight of 3 kg. The test specimen was then moved to and fro using 80 double strokes, whereupon the rams scratched the surface. The gloss was then again measured at the scratched sites. Table 5 shows the results. It is seen that the inventive films and, respectively, composite parts have substantially higher scratch resistance when compared with a PA12 surface.

TABLE 1
Measurement of chemicals resistance of a 250 μm monofilm

| | Comparative | Inventive | Inventive |
|---|---|---|---|
| | Example 1 | Example 1 | Example 2 |
| | PA MXD6 | PA MXD12/PA612 90:10^{a)} | PA MXD14 |
| Deionized | 61 | 74 | 74 |
| water | | | |
| 1% strength | 45 | 54 | 52 |
| sulphuric acid | | | |
| Pancreatin^{b)} | 33 | 74 | 49 |
| Tree resin | 46 | 74 | 74 |

^{a)}90 parts by weight of PA MXD12, 10 parts by weight of VESTAMID ® D16
^{b)}Model substance for bird droppings

TABLE 2
Gloss value of multilayer films

| | Comparative Example 2 | Inventive Example 3 | Inventive Example 4 | Inventive Example 5 | Inventive Example 6 |
|---|---|---|---|---|---|
| Outer layer (50 μm) | PA12 | PA MXD12 | PA MXD12/PA612 90:10 | PA MXD12/PA612 | PA MXD14 |
| | | | | 70:30 | |
| Color layer 1 (200 μm) | | | | PA12 black^{b)} | |
| Color layer 2 (400 μm) | PA12 black^{b)} | PA12 black^{b)} | PA12 black^{b)} | | PA12 black^{b)} |
| Adhesion promoter | | | | Admer ® QF 551E^{a)} | |
| (200 μm) | | | | | |
| Gloss 20° [gloss units] | 81 | 94.4 | 93 | 87.5 | 93 |
| | | | | | Inventive Example |
| | Inventive Example 7 | Inventive Example 8 | Inventive Example 9 | Inventive Example 10 | 11 |
| Outer layer (50 μm) | PA MXD10 | PA MXD13 | PA MXD18 | PA MXD12/PXD12 | PA MXD14/PA1010 |
| | | | | | (70:30) |
| Color layer 1 (200 μm) | PA12 black^{b)} | PA12 black^{b)} | PA12 black^{b)} | PA12 black^{b)} | PA12 black^{b)} |
| Color layer 2 (400 μm) | | | | | |
| Adhesion promoter | Admer ® QF 551E^{a)} | Admer ® QF 551E^{a)} | Admer ® QF 551E^{a)} | Admer ® QF 551E^{a)} | Admer ® QF 551E^{a)} |
| (200 μm) | | | | | |
| Gloss 20° [gloss units] | 95.1 | 92 | 89 | 92.5 | 95.3 |

^{a)}Functionalized polypropylene
^{b)}Molding composition composed of 67% by weight of PEBA, 28% by weight of PA12, 3% by weight of a color masterbatch with 16.9% by weight of carbon black pigment and 2% by weight of a stabilizer masterbatch

TABLE 3
Transmittance measurements on monofilms

| | Comparative | Inventive | Inventive Example | Inventive Example | Inventive | Inventive |
|---|---|---|---|---|---|---|
| | Example 3 | Example 12 | 13 | 14 | Example 15 | Example 16 |
| Material | PA12 | PA MDX12 | PA | PA | PA MXD14 | PA MXD10 |
| | | | MXD12/PA612 | MXD12/PA612 | | |
| | | | 90:10 | 70:30 | | |
| Transmittance [%] | 91.8 | 90.8 | 90.4 | 90.2 | 91 | 91.4 |
| (illuminant | | | | | | |
| D65/2°) | | | | | | |

| | Inventive Example 17 | Inventive Example 18 | Inventive Example 19 | Inventive Example 20 |
|---|---|---|---|---|
| Material | PA MDX13 | PA MDX18 | Co-PA MDX12/PXD12 | PA MXD14/PA1010 |
| | | | | 70:30 |
| Transmittance [%] | 91.1 | 90.4 | 90.8 | 90.2 |
| (illuminant D65/2°) | | | | |

TABLE 4
Wash-brush test on multilayer films reverse-coated by an injection-molding method

| | | Comparative | Inventive | | | |
|---|---|---|---|---|---|---|
| | | Example 4 | Example 17 | Inventive Example 18 | Inventive Example 19 | Inventive Example 20 |
| Outer layer (50 μm) | | PA12 | PA MXD12 | PA MXD12/PA612 | PA MXD12/PA612 | PA MXD14 |
| | | | | 90:10 | 70:30 | |
| Color layer 1 (200 μm) | | | | | PA12 black | |
| Color layer 2 (400 μm) | | PA12 black | PA12 black | PA12 black | | PA12 black |
| Adhesion promoter (200 μm) | | | | | Admer ® QF 551E | |
| Substrate | | PA12 | PA12 | PA12 | PA12 | PA12 |
| Prior: | Gloss 20° | 80.6 | 91.2 | 93.5 | 89.6 | 92.4 |
| | [Gloss units] | | | | | |
| Subsequent: | Gloss 20° | 11.4 | 43.5 | 37.5 | 35.3 | 25.6 |
| | [Gloss units] | | | | | |
| | Residual gloss [%] | 14.1 | 47.7 | 47.7 | 39.4 | 27.7 |
| | | Inventive | Inventive | | | |
| | | Example 21 | Example 22 | Inventive Example 23 | Inventive Example 24 | Inventive Example 25 |
| Outer layer (50 μm) | | PA MXD10 | PA MXD13 | PA MXD18 | Co-PA | PA MXD14/PA1010 |
| | | | | | MXD12/PXD12 | 70:30 |
| Color layer 1 (200 μm) | | PA12 black | PA12 black | PA12 black | PA12 black | PA12 black |
| Color layer 2 (400 μm) | | | | | | |
| Adhesion promoter (200 μm) | | Admer ® | Admer ® | Admer ® QF 551E | Admer ®QF 551E | Admer ® QF 551E |
| | | QF 551E | QF 551E | | | |
| Substrate | | PA12 | PA12 | PA12 | PA12 | PA12 |
| Prior: | Gloss 20° | 92.6 | 91.9 | 88.7 | 91.6 | 89.4 |
| | [Gloss units] | | | | | |
| Subsequent: | Gloss 20° | 46 | 35.1 | 22.6 | 41.5 | 25.3 |
| | [Gloss units] | | | | | |
| | Residual gloss [%] | 49.7 | 38.2 | 25.5 | 45.3 | 28.3 |

TABLE 5
Scratch resistance on multilayer films reverse-coated by an injection-molding method

| | | Comparative | | | |
|---|---|---|---|---|---|
| | | Example 5 | Inventive Example 26 | Inventive Example 27 | Inventive Example 28 |
| Outer layer (50 μm) | | PA12 | PA MXD12/PA612 90:10 | PA MXD12/PA612 70:30 | PA MXD14/PA1010 70:30 |
| Color layer 1 (200 μm) | | | | PA12 black | PA12 black |
| Color layer 2 (400 μm) | | PA12 black | PA12 black | | |
| Adhesion promoter (200 μm) | | | | Admer ® QF 551E | Admer ® QF 551E |
| Substrate | | PA12 | PA12 | SABIC | SABIC |
| | | | | STAMAX ® 30YM240^{a)} | STAMAX ® 30YM240^{a)} |
| Prior: | Gloss 20° | 82.7 | 92.3 | 90 | 88.5 |
| | [Gloss units] | | | | |

| | | | | | |
|---|---|---|---|---|---|
| Subsequent: | Gloss 20° | 2.4 | 65.2 | 54.5 | 40.5 |
| | [Gloss units] | | | | |
| | Residual gloss | 2.9 | 70.6 | 60.6 | 45.8 |
| | [%] | | | | |

^{a)}A molding composition of isotactic polypropylene with 30% of glass fiber

1. A decorative film having an outer layer comprising a polyamide composition comprising the following components:
a) from 50 to 100 parts by weight of polyamide prepared from the following monomers:
α) from 70 to 100 mol % of a diamine selected from m-xylylenediamine, p-xylylenediamine and mixtures thereof,
β) from 0 to 30 mol % of other diamines having from 6 to 14 carbon atoms,
where the mol % data are based on the entirety of the diamines, and
γ) from 70 to 100 mol % of aliphatic dicarboxylic acids having from 10 to 18 carbon atoms and
δ) from 0 to 30 mol % of other dicarboxylic acids having from 6 to 9 carbon atoms,
where the mol % data are based on the entirety of the dicarboxylic acids; and
b) from 0 to 50 parts by weight of another polyamide,
where the parts by weight of a) and b) total 100.

2. The decorative film according to claim 1,
wherein
component a) α) comprises at least 50% by weight of m-xylylenediamine and at most 50% by weight of p-xylylenediamine.

3. A decorative film according to claim 1,
wherein
component a) α) comprises more than 50% by weight of p-xylylenediamine and less than 50% by weight of m-xylylenediamine.

4. The decorative film according to claim 1, having only that outer layer.

5. The decorative film according to claim 1, comprising a plurality of layers.

6. The decorative film according to claim 5,
comprising
a color layer, a backing layer, and/or an adhesion-promoter layer.

7. The decorative film according to claim 6,
wherein
the color layer and/or the backing layer comprise(s) a polyamide elastomer or an impact-modifying rubber.

8. The decorative film according to claim 1,
wherein
its thickness is from 0.02 to 1.2 mm.

9. The decorative film according to claim 1,
wherein
the thickness of the outer layer is from 0.01 to 0.5 mm.

10. The decorative film according to claim 1,
wherein
it is produced via extrusion, coextrusion or lamination and is then, if appropriate, subjected to a forming process.

11. A composite part comprising a film according to claim 1 and a substrate.

12. The composite part according to claim 11, in the form of a bodywork part of a motor vehicle, a constituent of the interior of a motor vehicle, cladding, a decorative strip, a cover strip, a panel or a decorative element.

13. The composite part according to claim 11, in the form of sports equipment.

14. The composite part according to claim 11,
wherein
it is produced via adhesive bonding, pressing, lamination, coextrusion, or reverse-coating by an injecting-molding, foaming or compression-molding method.
